(19) United States
(12) Patent Application Publication
(10) Pub. No.: US 2024/0144274 A9
(43) Pub. Date: May 2, 2024

(54) TRANSACTION-RISK EVALUATION BY RESOURCE-LIMITED DEVICES

(71) Applicant: INTERNATIONAL BUSINESS MACHINES CORPORATION, Armonk, NY (US)

(72) Inventors: Tamas Visegrady, Zurich (CH); Andrea Giovannini, Zurich (CH)

(21) Appl. No.: 17/658,488

(22) Filed: Apr. 8, 2022

(51) Int. Cl. G06Q 20/40

(52) U.S. Cl. CPC G06Q 20/4016; G06Q 20/4014; G06Q 20/407

(57) ABSTRACT

A computer-implemented method for enabling transaction-risk evaluation by resource-limited devices. The method includes receiving from a financial network transaction data, defining transactions in the network, and generating, based on the transaction data, a transaction graph comprising nodes, representing parties to transactions, interconnected by edges representing transactions between parties represented by the nodes. For each of at least some nodes, at least one risk attribute provided in the transaction graph. The method includes receiving from a resource-limited device a request describing a potential transaction, identifying at least one counterparty node, deriving transaction-risk data, dependent on aggregated risk attributes of the counterparty node and a selected set of nodes reachable from that node via edges, and sending to the device a response comprising the transaction-risk data for evaluation of risk of the potential transaction.

### BACKGROUND

The present invention relates generally to transaction-risk evaluation by resource-limited devices. Computer-implemented methods are provided for enabling transaction-risk evaluation by resource-limited devices, together with systems and computer program products implementing such methods.

### SUMMARY

A first aspect of the present invention provides a computer-implemented method for enabling transaction-risk evaluation by resource-limited devices. The method includes receiving from a financial network transaction data, defining transactions in the network, and generating, based on the transaction data, a transaction graph comprising nodes, representing parties to transactions, interconnected by edges representing transactions between parties represented by the nodes. For each of at least some nodes, at least one risk attribute, indicating a measure of risk associated with the party represented by that node, is provided in the transaction graph. The method includes receiving from a resource-limited device a request describing a potential transaction by that device, and identifying in the transaction graph at least one counterparty node which represents a counterparty to the potential transaction. The method further comprises deriving transaction-risk data, dependent on aggregated risk attributes of the counterparty node and a selected set of nodes reachable from that node via edges in the transaction graph, and sending to the resource-limited device a response comprising the transaction-risk data for evaluation, at the device, of risk of the potential transaction.

Another aspect of the invention provides a system for evaluating transaction-risk, the system comprising a server and at least one resource-limited device which is adapted to send to the server a request describing a potential transaction by that device. The server is adapted to perform a method for enabling transaction-risk evaluation as described above, and the resource-limited device is adapted to evaluate risk of the potential transaction in dependence on the transaction-risk data from the server and local risk-evaluation data at the device.

A further aspect of the invention provides a computer program product comprising a computer readable storage medium embodying program instructions, executable by a computing apparatus, to cause the computing apparatus to implement a method for enabling transaction-risk evaluation by resource-limited devices as described above.

Embodiments of the invention will be described in more detail below, by way of illustrative and non-limiting example, with reference to the accompanying drawings.

### BRIEF DESCRIPTION OF THE SEVERAL VIEWS OF THE DRAWINGS

FIG. 1 is a schematic representation of a computing system for implementing methods embodying the invention;

FIG. 2 illustrates components of an exemplary computing system for implementing transaction-risk evaluation methods embodying the invention;

FIGS. 3a and 3b indicate steps of a transaction-risk evaluation process in the FIG. 2 system;

FIG. 4 a schematic illustrating structure of a transaction graph generated by the system;

FIGS. 5 and 6 illustrate techniques for deriving transaction-risk data in embodiments of the system;

FIG. 7 indicates steps of a transaction graph generation process in a preferred embodiment of the system;

FIG. 8 illustrates features of a transaction graph generated by the FIG. 7 process;

FIG. 9 indicates steps of a transaction-risk evaluation process in a preferred embodiment of the system; and

FIG. 10 indicates steps of a dynamic update process in preferred embodiments of the system.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN) and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments to be described can be performed as computer-implemented methods for enabling transaction-risk evaluation by resource-limited devices. Such methods may be implemented by a computing system comprising one or more general- or special-purpose computers, each of which may comprise one or more (real or virtual) machines, providing functionality for implementing operations described herein. Steps of methods embodying the invention may be implemented by program instructions, e.g., program modules, implemented by a processing apparatus of the system. Generally, program modules may include routines, programs, objects, components, logic, data structures, and so on that perform particular tasks or implement particular abstract data types. The computing system may be implemented in a distributed computing environment, such as a cloud computing environment, where tasks are performed by remote processing devices that are linked through a communications network. In a distributed computing environment, program modules may be located in both local and remote computer system storage media including memory storage devices.

FIG. 1 is a block diagram of an exemplary computing apparatus for implementing methods embodying the invention. The computing apparatus is shown in the form of a general-purpose computer 1. The components of computer 1 may include processing apparatuses such as one or more processors represented by a processing unit 2, a system memory 3, and a bus 4 that couples various system components including system memory 3 to processing unit 2.

Bus 4 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 1 typically includes a variety of computer readable media. Such media may be any available media that is accessible by computer 1 including volatile and non-volatile media, and removable and non-removable media. For example, system memory 3 can include computer readable media in the form of volatile memory, such as a RAM 5 and/or a cache memory 6. Computer 1 may further include other removable/non-removable, volatile/non-volatile computer system storage media. By way of example only, a storage system 7 can be provided for reading from and writing to a non-removable, non-volatile magnetic medium (commonly called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can also be provided. In such instances, each can be connected to bus 4 by one or more data media interfaces.

Memory 3 may include at least one program product having one or more program modules that are configured to carry out functions of embodiments of the invention. By way of example, a program/utility 8, having a set (at least one) of program modules 9, may be stored in memory 3, as well as an operating system, one or more application programs, other program modules, and program data. Each of the operating system, one or more application programs, other program modules, and program data, or some combination thereof, may include an implementation of a networking environment. Program modules 9 generally carry out the functions and/or methodologies of embodiments of the invention as described herein.

Computer 1 may also communicate with: one or more external devices 10 such as a keyboard, a pointing device, a display 11, etc.; one or more devices that enable a user to interact with computer 1; and/or any devices (e.g., network card, modem, etc.) that enable computer 1 to communicate with one or more other computing devices. Such communication can occur via Input/Output (I/O) interfaces 12. Also, computer 1 can communicate with one or more networks such as a LAN, a general WAN, and/or a public network (e.g., the Internet) via a network adapter 13. As depicted, network adapter 13 communicates with the other components of computer 1 via bus 4. Computer 1 may also communicate with additional processing apparatuses 14, such as a graphics processing unit (GPU) or a FPGA, for implementing embodiments of the invention. It should be understood that although not shown, other hardware and/or software components could be used in conjunction with computer 1. Examples include, but are not limited to: microcode, device drivers, redundant processing units, external disk drive arrays, redundant array of independent disks (RAID) systems, tape drives, and data archival storage systems, etc.

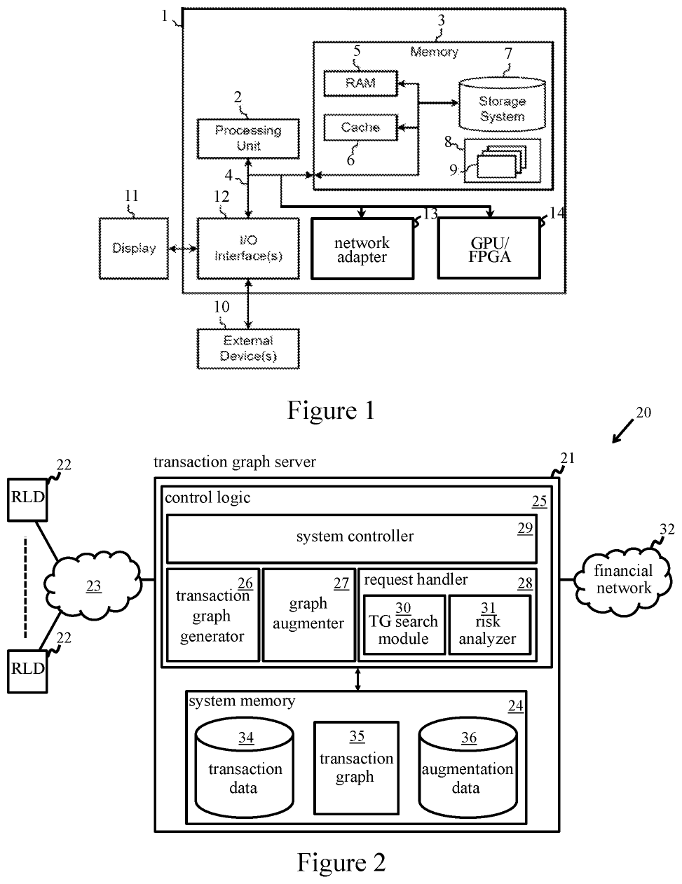

The FIG. 2 schematic illustrates components of an exemplary computing system 20 for enabling evaluation of transaction-risk by resource-limited devices. The system 20 comprises a server (“transaction graph server”) 21, which is adapted for communication with resource-limited devices (RLDs) 22 via a network 23. The transaction graph (TG) server 21 comprises system memory 24 and a control logic, indicated generally at 25, comprising functionality for enabling RLDs 22 to evaluate risk of their potential transactions. The control logic 25 comprises a transaction graph generator 26, a graph augmenter module 27, a request handler 28 and a system controller 29. The request handler 28 comprises a transaction graph (TG) search module 30 and a risk analyzer module 31. Each of these logic modules 26 through 31 comprises functionality for implementing particular steps of a transaction-risk evaluation process detailed below. The system controller 29 receives transaction data used in this process from a financial network 32, and controls operation of modules 26 through 31 at various stages of the process.

Logic modules 26 through 31 interface with system memory 24 which stores various data structures used in operation of system 20. These data structures include the transaction data 34 which is received by system controller 29 and defines transactions in financial network 32, and a transaction graph (TG) 35 which is generated by transaction graph (TG) generator 26 based on transaction data 34. System memory 24 may also store a set of graph augmentation data 36. This data is compiled by graph augmenter 27 in preferred embodiments below and is used to augment information represented in TG 35.

In general, functionality of logic modules 26 through 31 may be implemented by software (e.g., program modules) or hardware or a combination thereof. Functionality described may be allocated differently between system modules in other embodiments, and functionality of one or more modules may be combined. The TG server 21 may be implemented by one or more computers of a computing system. For example, all modules may be provided in computer 1 which implements all TG server functionality, or modules may be provided in a plurality of computers to which RLDs 22 can connect via network 23. System memory 24 may be implemented by one or memory/storage components associated with one or more computers of system 20. The TG server 21 may be local or remote from the financial network 32 and may be integrated in the network in some embodiments. Network 23 may comprise one or more component networks and/or internetworks, including the Internet, and may incorporate financial network 32.

The financial network 32 may comprise one or more networks of computers implementing transactions between accounts in a bank, consortium of banks and/or other monetary processing systems, including electronic transaction systems such as the Bitcoin transaction network. The transaction data 34 can be compiled over a period of time such as a number of months (e.g., a financial quarter), a financial year, or longer periods of multiple years for which transaction records are available. Preferred embodiments use transaction data acquired over at least a year of operation of a large financial network comprising multiple component transaction networks. For each transaction, the transaction data comprises a transaction party (i.e., account owner) identifier for the sender and recipient, and typically includes the transfer amount and a transaction timestamp indicating date and time of the transaction. Any additional data recorded in financial network 32 for transactions, such as purpose of the transaction (e.g., utility bill payment, travel expenses, tax payment, etc.,), account type (e.g., private individual or company/business account) and so on, may also be provided and can be exploited by embodiments below. The transaction data 34 may be accessed dynamically from one or more servers in financial network 32 or may be precompiled for system operation and stored in system memory 24.

The RLDs 22 served by TG server 21 may comprise user computers such as desktop computers, mobile computing devices (e.g., laptops, tablets, mobile phones, etc.) or other Internet of Things (IoT) devices which have functionality for performing financial transactions, but whose storage and/or processing resources are insufficient for storing and/or processing significant amounts of transaction data to evaluate risk of their potential transactions. In a typical financial network 32, transactions are analyzed with the aim of detecting fraudulent activity, such as money laundering, trader fraud, or other suspect transactions. For example, automated anti-money laundering (AML) processes use various techniques for analysing large transaction networks to detect potentially-fraudulent transaction patterns and identify suspect parties to transactions. Such techniques involve sophisticated processing applied over large datasets of transaction data, well beyond the capabilities of most IoT devices performing their own transactions. Risk factors applicable to individual transactions by RLDs may be embedded in the transaction history in financial network 32, but RLDs cannot access and process the data necessary to perform local risk-evaluation for their own transactions. Conversely, it is infeasible for RLDs to store risk factors derived in the financial network for all potential counterparties to their transactions. While RLDs can use local risk-evaluation data, such as risk thresholds and/or other rules/criteria (which may depend on transaction type/size, local preferences/user settings, etc., and potentially their own transaction history where this is stored locally) to assess risk of a potential transaction, this localized data, and the resulting risk evaluation, is inherently limited.

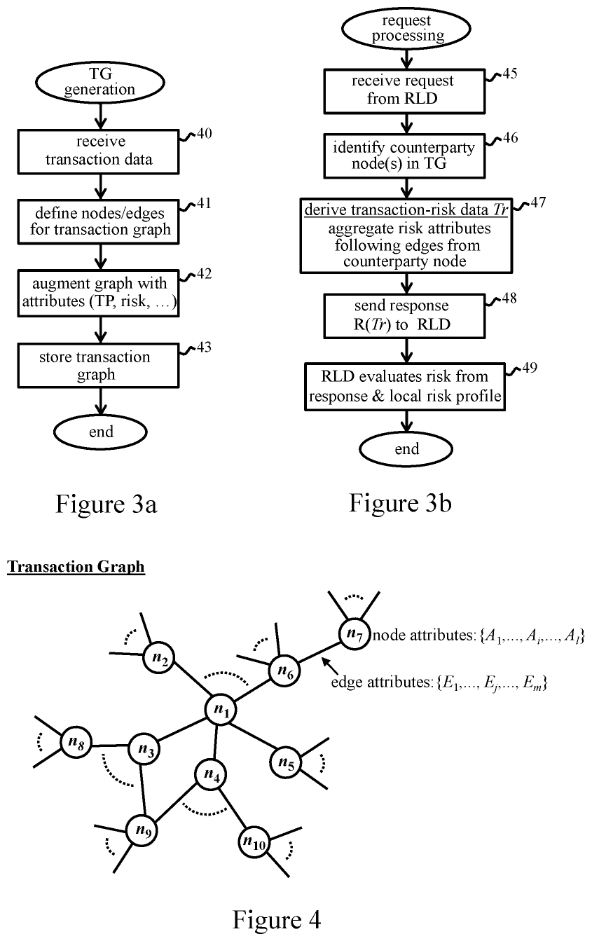

Operation of system 20 is illustrated in the flow diagrams of FIGS. 3a and 3b. FIG. 3a indicates basic steps of a transaction graph generation process in TG server 21. Step 40 represents receipt by system controller 29 of the transaction data 34 from financial network 32. In step 41, TG generator 26 analyzes the transaction data 34 to define nodes and edges of a TG. Basic structure of the TG is illustrated schematically in FIG. 4. The TG comprises nodes, indicated by circles, interconnected by edges indicated by lines between nodes. Nodes (labeled n₁, n₂, n₃, . . . in the partial view shown) represent parties to transactions defined in transaction data 34. Edges represent transactions between parties represented by the nodes. This TG structure may be defined by node identifiers n₁, n₂, . . . n_{N} for N transaction parties and an N-by-N binary adjacency matrix in which a “1” at position (p, q) in the matrix indicates presence of an edge between a node nₚ and a node n_{q}.

In step 42, the graph augmenter 27 augments the TG with attributes. In particular, a set of node attributes {A_{i=1 to 1}} is defined for nodes, where each attribute Aᵢ may be defined by a (name:value) pair or tuple. Attributes {Aᵢ} defined for a node comprise a transaction party (TP) identifier, e.g., (TPname:XYZ), determined from transaction data 34, and at least one risk attribute which indicates a measure of risk associated with the TP represented by that node. The risk attribute(s) for a node preferably depend on at least one of a credit rating for the TP represented by a node, a net worth of the TP, and a suspect-transaction indicator indicating involvement by that party in suspect transaction patterns. For example, the transaction data 34 may include suspect-transaction indicators, derived by AML or other analysis processes in financial network 32, associated with parties involved in potentially-suspect transaction patterns. Such an indicator may comprise a simple flag, or a value indicative of probability of involvement in suspect activity. Where such indicators are provided in transaction data 34, the graph augmenter 27 can define a corresponding risk attribute for nodes of the TG. In preferred embodiments below, such suspect-transaction indicators can also be derived by TG server 21. A risk attribute may also be based on credit rating for a TP. This may be provided in transaction data 34 in some scenarios, or credit ratings may be determined by the graph augmenter 27. In particular, dedicated program tools can be provided in graph augmenter 27 for accessing information sites, such as credit agencies, company registries, etc., via network 23 to retrieve information about TPs. Risk attributes can then be defined for TPs based on retrieved credit scores. Another risk attribute here may be based on a net worth of the TP which may be determined by graph augmenter 27 by accessing company registries for TP accounts data. Various further node attributes can be defined for TPs in preferred embodiments below. The resulting node attributes {Aᵢ} defined by graph augmenter 27 are associated with their corresponding nodes in TG 35.

Graph augmenter 27 may also define attribute sets {E_{j=1 to m}} for edges of the TG. For example, edge attributes may comprise transaction attributes dependent on transaction amounts and transaction timestamps indicated in transaction data 34 for transactions. For example, transaction amounts and times may be indicated by corresponding (name:value) pairs/tuples. Amounts/times may be recorded individually in attributes or transaction amounts may be accumulated over defined time intervals for transaction parties. Various further edge attributes {Eⱼ} can be defined in preferred embodiments below. Note also that, while transaction edges are indicated by single lines in FIG. 4, in practice edges may be directed to indicate transfer direction between TPs, and different edges may be defined for different transactions or types of transaction, e.g., where transaction purpose (utility bill payment, travel expenses, etc.,) is indicated in transaction data 34. The resulting TG 35, augmented with all attributes, is stored in system memory 24 in step 43.

After generation of the TG, an RLD 22 at which a potential transaction is to be evaluated can generate a request, describing the transaction, and send the request to TG server 21 via network 23. A dedicated API (Application Programming Interface) can be provided at RLDs 22 for this purpose, and all communications can be tunneled through secure channels. FIG. 3b indicates system operation in response to such a request. The request is received by TG server 21 in step 45 and passed to request handler 28. In step 46, the TG search module 30 analyses the request and searches the TG to identify at least one counterparty node (CP node) representing a counterparty (CP) to the potential transaction described in the request. RLD requests may describe transactions in various ways. For instance, a request may identify a specific CP for the transaction, in which case TG search module 30 locates the TG node corresponding to that CP. In other instances, explained below, requests may define an intended transaction by specifying a set of “preferences” which, while not specifying a particular CP, can be “matched” to one or more nodes of the TG representing potential counterparties for the RLD transaction. Hence, TG search module 30 uses information provided in the request to identify one or more CP nodes as appropriate.

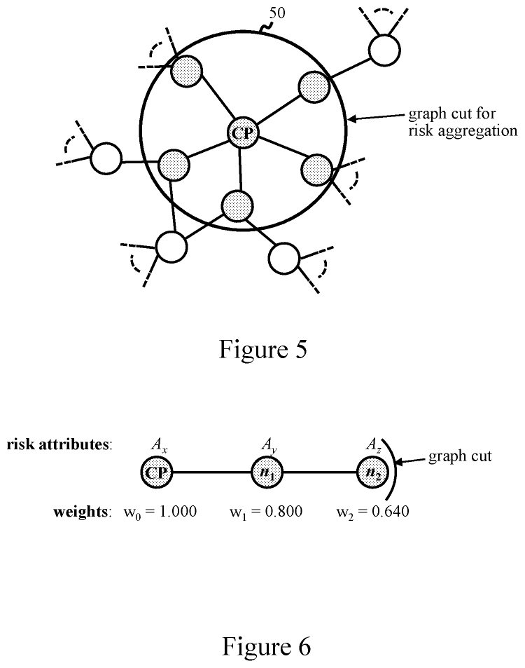

In step 47, the risk analyzer 31 then derives transaction-risk data for the (or each) CP node identified for the request. This transaction-risk data Tr is dependent on aggregated risk attributes of the CP node and a selected set of nodes reachable from that node via edges in the TG. For example, this set of nodes may be selected to comprise all nodes within a predetermined number h of hops (edge traversals) from the CP node. The value of h thus defines the boundary, or “graph cut”, of a subgraph in the TG over which risk attributes are aggregated. This is illustrated in FIG. 5 for a simple scenario with h=1, whereby the selected set of nodes is the set of immediate neighbor nodes of the CP node. Risk attributes of all nodes, shaded grey in the figure, within a graph cut 50 are then aggregated to obtain the transaction-risk data Tr. The resulting data Tr thus accommodates risk factors associated not only with the direct CP for the RLD transaction, but also those parties with which that CP has performed financial transactions.

Risk attributes may be aggregated in various ways to obtain the transaction-risk data Tr. In simple embodiments, Tr may comprise an overall risk value computed as a function (e.g., some type of average) of all risk attributes of nodes within the cut, or as a vector of risk values each computed as a function of corresponding risk attributes of these nodes. Other embodiments may provide a vector of risk values for the cut, where each risk value is computed over risk attributes of nodes along individual paths from the CP node to boundary nodes on the cut. Risk attributes may thus be assembled, accumulated, or otherwise combined to produce transaction-risk data Tr comprising at least one risk value dependent on risk attributes for the graph cut.

In preferred embodiments, the transaction-risk data Tr can accommodate wider transaction relationships than immediate neighbors of the CP node. For example, the graph cut 50 may comprise a set of neighbor nodes reachable from the CP node via a plurality of hops h in the TG. Preferred embodiments also weight risk attributes of nodes in dependence on the number of hops between each node and the CP node, such that nodes more distant from the CP node contribute less to the resulting risk value(s). This is illustrated in FIG. 6 which shows a 2-hop path in the TG from the CP node to the graph cut 50. The CP node has a risk attribute Aₓ here, and the nearest neighbor n₁ and next neighbor n₂ have corresponding risk attributes A_{y} and A_{z} respectively. When aggregating risk attributes Aₓ, A_{y} and A_{z} to obtain the transaction-risk data Tr, the risk attributes are weighted by weights w₀, w₁ and w₂ respectively, whereby Tr comprises a function F of w₀Aₓ, w₁A_{y} and w₂A_{z}. The weights w₀, w₁, w₂ are defined such that the contribution of risk values to F decreases with number of hops from CP, conveniently by an exponential averaging process. This technique allows wider transaction relationships in the TG topology to be accommodated in risk evaluation, while addressing decreasing relevance of risk factors with distance from the CP node.

Returning to FIG. 3b, in step 48 the request handler 28 sends a response, denoted by R(Tr), comprising the transaction-risk data Tr derived for the (or each) CP node identified in step 46. In step 49, the RLD 22 can then evaluate risk of its potential transaction based on both Tr and its own local risk-evaluation data (local “risk profile”), such as potentially-varying risk thresholds and/or other rules/criteria specific to that particular device.

It will be appreciated that, by deriving transaction-risk data Tr in response to RLD requests, the TG server 21 can provide an RLD with compressed risk information which is not only specific to the RLD's individual transaction, but also accommodates risk factors encoded in attributes and topology of the TG. The aggregation of risk attributes for cuts of the TG accommodates indicators of suspect activity which extend beyond any individual transaction party in the TG. Numerous real-life examples demonstrate that individual parties/transactions can appear entirely legitimate, while transaction patterns involving multiple parties can reveal evidently fraudulent activity. The compressed risk information provided by TG server 21 is adaptive to individual transactions, and to arbitrary counterparties, and can be readily processed by RLDs 22. This allows RLDs to process dynamic risk information, specific to an individual transaction, which accommodates risk factors embedded in large transaction networks and is beyond the capabilities of RLDs to derive for their own transactions. RLDs can thus decide how to manage their potential transactions based on both local risk profiles and dynamically-derived, compressed risk information for individual transactions.

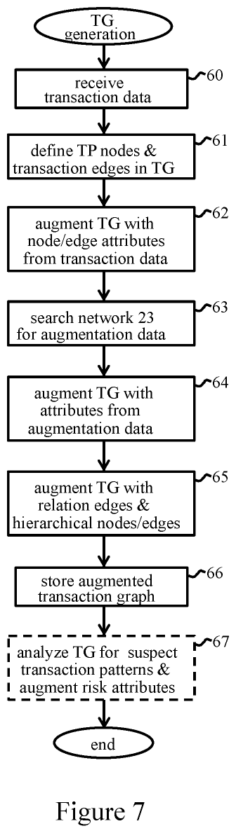

Operation of a preferred embodiment of system 20 will now be described in more detail. In this embodiment, graph augmenter 27 augments the TG 35 with additional features for enhanced system operation. FIG. 7 indicates steps of the TG generation process in this embodiment. Steps 60 and 61 correspond to steps 40 and 41 of FIG. 3a. In step 62, graph augmenter 27 defines initial attribute sets for nodes and edges of the TG 35 using all information derivable from the transaction data 34. Initial node attributes here comprise TP identifiers and any risk attributes, such as suspect-transaction indicators, provided in the transaction data as described above. Initial edge attributes comprise transaction attributes based on transaction amounts/times as described above, and may include transaction-purpose attributes (e.g., utility bill payment, travel expenses, etc.,) where such information is provided in transaction data 34. In step 63 here, graph augmenter 27 uses dedicated program tools to search network 23 for additional information on TPs. These tools may access numerous websites including company registries, credit agencies, business directories, proprietary TP websites, online encyclopedias, company/product comparison sites, product review sites and other secondary information sources, to extract information relevant to TPs. The results of these search processes are stored as augmentation data 36 in system memory 24.

In step 64, graph augmenter 27 analyzes the augmentation data to derive additional node/edge attributes for the TG 35. A key node attribute here is a business-type attribute indicating a business-type (such as airline, travel agent, electronics merchant, private individual, and so on) of the party represented by a TP node. Further attributes which can be defined here for nodes include attributes indicating one or more of business size, location, business value, market position, reputation, business activities, past regulatory interactions, business products (goods or services), product prices and product ratings, along with additional risk attributes, e.g., based on credit ratings and/or net worth, as indicated in the augmentation data. The resulting, augmented sets of node attributes {Aᵢ} are associated with their corresponding TP nodes in transaction graph 35. Graph augmenter 27 can then analyze the augmented TG structure to deduce additional attributes for edges representing transactions (“transaction edges”) in the TG 35. In particular, for at least some transaction edges, the graph augmenter 27 can deduce transaction-purpose attributes from the augmented TP node attributes for TP nodes connected by a transaction edge. The attributes {Eⱼ} for transaction edges are augmented accordingly.

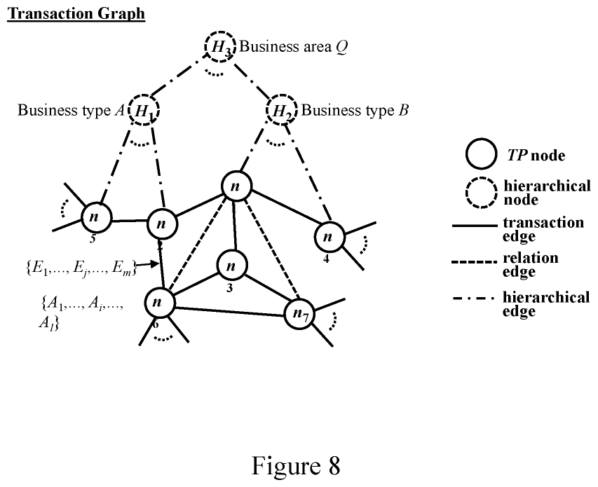

In step 65, the graph augmenter 27 further augments the TG 35 with additional nodes and/or edges. For example, “relation edges” can be defined to indicate an ownership relation between parties represented by TP nodes where such relation is indicated by augmentation data 36. Nodes can also be clustered in various ways based on TP node attributes. The business-type attribute allows clustering of TP nodes by business-type (e.g., airlines, travel agents, etc.,), and additionally by overall business area (e.g., travel). Hierarchical nodes and edges can be added to the graph to represent the various clusters. FIG. 8 shows a portion of a TG augmented with such additional structure. In this example, hierarchical nodes H₁ and H₂ represent respective business types A and B and are linked, via hierarchical edges, to their underlying TP nodes with the corresponding business-type attributes. Hierarchical node H₃ represents a cluster for a business area Q containing hierarchical nodes H₁ and H₂. Relation edges are also provided between nodes n₆ and n₇ and an owning-entity node n₁. Relation edges thus indicate related entities even if no transactions occurred between these entities. The additional nodes/edges added in step 65 can be assigned appropriate attributes to identify particular node/edge types.

The augmented TG 35, enriched with additional attributes and topology derived from augmentation data 36, is stored in system memory 24 at step 66. Step 67 represents an optional additional process in graph augmenter 27. Here, the graph augmenter 27 may analyze the augmented TG for suspect transaction patterns and derive (additional) suspect-transaction indicators for TP nodes involved in such patterns. Known AML techniques can be employed here to analyze node and transaction attributes and identify predetermined types of transaction pattern commonly associated with fraudulent activity. As an illustrative examples, the graph augmenter 27 may identify: nodes/groups of nodes which always deduct some function of otherwise simply forwarded transfers (addressing typical support models of Bitcoin-laundering ‘mixers’ and similar fraudulent services); and circular transaction patterns such as groups of variable numbers of nodes which circulate transfer amounts (addressing circulation of funds to fraudulently inflate revenues or comparable self-dealing between coordinated cliques, such as so-called “wash trades”). The relation edges and augmented TG attributes can enhance these techniques, allowing activity of related companies to be accommodated in the analysis and unusual transaction types, or unusual links between different business types, to be identified. Risk attributes for TP nodes can be supplemented with suspect-transaction indicators based on results of this analysis.

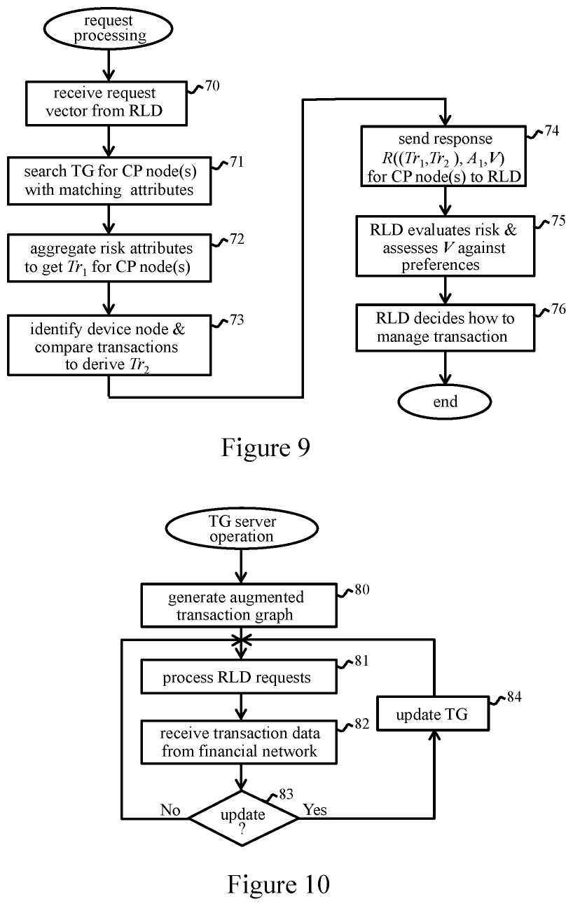

FIG. 9 illustrates system operation in response to an RLD request. In this embodiment the RLD request, received by request handler 28 in step 70, comprises a vector of attributes describing the potential transaction. Attributes in this vector correspond to attributes in the augmented TG. The request vector may therefore include specific attributes Aᵢ defined for TP nodes, and may identify one specific counterparty for the transaction or may define “preferences” for the transaction, in terms of a desired set of TP attributes, which can be mapped to attributes of one or more TP nodes. In step 71, the TG search module searches TG 35 to identify at least one CP node having attributes matching those in the request vector. (The criteria for an attribute match may accommodate some leeway here, e.g., based on priorities/margins specified in the request). This search can be conducted efficiently in the augmented TG by propagating the request vector via hierarchical nodes/edges of the graph. For the or each CP node located for the request, the risk analyzer 31 derives transaction-risk data in step 72 by aggregating risk attributes for a graph cut 50 as previously described. The resulting risk value(s) obtained by this aggregation process constitute a first component, denoted by Tr₁, of the transaction-risk data Tr here.

In step 73 of this embodiment, the search module also identifies a “device node” in the TG, where this device node is a TP node corresponding to the RLD which sent the request. Risk analyzer 31 then compares the current transaction, as described in the request vector, with transactions represented in the TG for that device node. For example, the risk analyzer 31 may compare amount, time, transaction-purpose and CP attributes for the device node's previous transactions with corresponding attributes in the current RLD request. Based on this comparison, the risk analyzer 31 can determine whether the RLD's potential transaction is consistent with its past transaction history, e.g., a regular payment or a payment for a purpose, amount, counterparty, etc., which is “usual” for that RLD. The risk analyzer 31 can then produce a “consistency indicator”, comprising one or more values, indicating the results of this assessment. The consistency indicator constitutes a second component, denoted by Tr₂, of the transaction risk data Tr here.

In step 74, the request handler sends a response R to the RLD, where the form of this response depends on the content and results of the RLD request. If the request specified one particular counterparty, the response may simply comprise the transaction risk data (Tr₁, Tr₂) derived for that CP node. If one or more CP nodes was identified by attribute-matching for the request, then the response comprises, for each CP node, the transaction-risk data (Tr₁, Tr₂) for that node and at least the node attribute, here A₁, identifying the party represented by that node. In addition, the response may include, for each CP node, a vector V of the node attributes {Aᵢ} corresponding to attributes/preferences specified in the request vector. On receipt of this response in step 75, the RLD can evaluate the transaction-risk data (Tr₁, Tr₂) in relation to its local risk profile, and assess CP node attributes (where provided) against its transaction preferences. In step 76, the RLD can decide how to manage the potential transaction based on the results of this evaluation. For example, the device may decide to proceed/not proceed with a transaction with a specific CP, or to choose a CP with acceptable risk and the best attribute-match among a choice of CPs for the transaction, or to display results via a user interface for user input on a transaction decision.

FIG. 10 illustrates dynamic operation of TG server 21 in the system. Step 80 represents generation of the augmented TG as in FIG. 7, and step 81 represents processing of RLD requests as in FIG. 8. In step 82, the TG server continues to receive new transaction data from financial network 32. In step 83, the TG server 21 decides if a scheduled update period (e.g., a month or financial quarter) has expired. If so the TG 35 is updated in step 84 to accommodate the new transaction data, and operation reverts to step 81.

It will be seen that the TG server 21 provides a highly-efficient mechanism for adaptive discovery of time-dependent transaction information tailored to individual RLD requests. RLDs 22 are provided with compressed transaction-risk data, derived dynamically based on topology and attributes of the TG 35, which can be readily processed by RLDs 22 for local risk evaluation of their individual transactions.

The request processing operation of FIGS. 3b and 9 may be performed for some or all RLD requests. In some embodiments, for example, aggregation of risk attributes over graph cuts may be performed only for CP nodes whose risk attributes indicate more than a threshold degree of risk. Various other alternatives and modifications can of course be envisaged. The size of the graph cut for risk aggregation may be determined dynamically based on degree of risk indicated by risk attributes of CP and/or neighboring nodes. For example, the number of hops h along any given path from the CP node may depend on risk attributes of individual neighbor nodes in the path such that high-risk nodes result in additional hops. Responses to RLD requests may include additional data tailored to RLD processing capabilities. For example, a response may include the entire graph cut/subgraph, with aggregated risk attributes and possibly temporally-aggregated transaction attributes, for analysis locally where RLDs are capable of this. Where RLDs can store their own transaction history locally, step 73 may be omitted for requests from those RLDs.

In general, where features are described herein with reference to a method embodying the invention, corresponding features may be provided in a system/computer program product embodying the invention, and vice versa.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for enabling transaction-risk evaluation by resource-limited devices, the method comprising:
receiving from a financial network transaction data defining transactions in the network;
generating, based on said transaction data, a transaction graph comprising nodes, representing parties to the transactions, interconnected by edges representing the transactions between parties represented by the nodes;
providing in the transaction graph, for each of at least some of the nodes, at least one risk attribute indicating a measure of risk associated with the party represented by that node;
receiving from a resource-limited device a request describing a potential transaction by that device;
identifying in the transaction graph at least one counterparty node which represents a counterparty to said potential transaction;
deriving transaction-risk data dependent on aggregated risk attributes of the counterparty node and a selected set of nodes reachable from that counterparty node via edges in the transaction graph; and
sending to the resource-limited device a response comprising said transaction-risk data for evaluation, at the device, of risk of the potential transaction.

2. A method as claimed in claim 1 wherein said transaction-risk data comprises at least one risk value dependent on said aggregated risk attributes of the counterparty node and the selected set of nodes.

3. A method as claimed in claim 1 wherein said selected set of nodes comprises a set of immediate neighbor nodes of the counterparty node.

4. A method as claimed in claim 1 wherein said selected set of nodes comprises a set of neighbor nodes reachable from the counterparty node via a plurality of hops in the transaction graph.

5. A method as claimed in claim 2 including deriving said at least one risk value by weighting aggregating risk attributes of nodes in said selected set of nodes in dependence on the number of hops between each node and the counterparty node such that nodes more distant from the counterparty node contribute less to said at least one risk value.

6. A method as claimed in claim 5 including weighting said aggregated risk attributes via an exponential averaging process.

7. A method as claimed in claim 1 including providing relation edges in the transaction graph indicating an ownership relation between parties represented by nodes interconnected by a relation edge.

8. A method as claimed in claim 1 wherein said at least one aggregated risk attribute for a node depends on at least one of a credit rating for the party represented by that node, a net worth of the party represented by that node, and a suspect-transaction indicator indicating involvement by that party in suspect transaction patterns in said financial network.

9. A method as claimed in claim 8 wherein:
the transaction graph includes transaction attributes dependent on transaction amounts and transaction times for the transactions represented in the transaction graph; and
the method includes analyzing the transaction graph to derive one said suspect-transaction indicator for each of at least some nodes of the transaction graph.

10. A method as claimed in claim 1 including providing in the transaction graph, for each of at least some nodes, a business-type attribute indicating a business-type of the party represented by that node.

11. A method as claimed in claim 1 including providing, for the transactions represented by the edges in the transaction graph, transaction-purpose attributes indicating a purpose of respective transactions.

12. A method as claimed in claim 1 including identifying in the transaction graph a device node corresponding to the resource-limited device, and comparing said potential transaction with the transactions represented in the transaction graph for the device node, wherein said transaction-risk data is further dependent on a result of that comparison.

13. A method as claimed in claim 10 including providing for each of at least some nodes in the transaction graph, at least one further attribute indicating, for the party represented by that node, at least one of business size, location, business value, market position, reputation, business activities, regulatory interactions, business products, product prices, and product ratings.

14. A method as claimed in claim 13 wherein:
said request from the resource limited device comprises a vector of attributes describing the potential transaction;
the method includes identifying in the transaction graph at least one counterparty node having attributes matching those in said vector and deriving said transaction-risk data for that counterparty node; and
said response comprises, for each counterparty node so identified, the transaction-risk data for that node and an attribute indicating the party represented by that node.

15. A method as claimed in claim 14 wherein said response includes a vector of attributes of the counterparty node corresponding to attributes in said vector describing the potential transaction.

16. A method as claimed in claim 1 including, after generating the transaction graph, receiving from said financial network new transaction data defining transactions in the network, and updating the transaction graph based on said new transaction data.

17. A system for evaluating transaction-risk, the system comprising a server and at least one resource-limited device which is adapted to send to the server a request describing a potential transaction by that device, wherein the server is adapted:
to receive from a financial network transaction data defining transactions in the financial network;
to generate, based on said transaction data, a transaction graph comprising nodes, representing parties to the transactions, interconnected by edges representing the transactions between parties represented by the nodes;
to provide in the transaction graph, for each of at least some nodes, at least one risk attribute indicating a measure of risk associated with the party represented by that node; and
in response to said request from the resource-limited device, to identify in the transaction graph at least one counterparty node which represents a counterparty to said potential transaction, to derive transaction-risk data dependent on aggregated risk attributes of the counterparty node and a selected set of nodes reachable from that node via the edges in the transaction graph, and to send to the resource-limited device a response comprising said transaction-risk data;
and wherein said resource-limited device is adapted to evaluate risk of the potential transaction in dependence on said transaction-risk data and local risk-evaluation data at the device.

18. A system as claimed in claim 17 wherein the resource-limited device is adapted to decide how to manage the potential transaction in dependence on said response from the server.

19. A system as claimed in claim 17 wherein the server is adapted such that said transaction-risk data comprises at least one risk value dependent on said aggregated risk attributes of the counterparty node and the selected set of nodes.

20. A computer program product for enabling transaction-risk evaluation by resource-limited devices, said computer program product comprising a computer readable storage medium having program instructions embodied therein, the program instructions being executable by a computing apparatus to cause the computing apparatus to:
receive from a financial network transaction data defining transactions in the network;
generate, based on said transaction data, a transaction graph comprising nodes, representing parties to the transactions, interconnected by edges representing the transactions between parties represented by the nodes;
provide in the transaction graph, for each of at least some nodes, at least one risk attribute indicating a measure of risk associated with the party represented by that node;
receive from a resource-limited device a request describing a potential transaction by that device;
identify in the transaction graph at least one counterparty node which represents a counterparty to said potential transaction;
derive transaction-risk data dependent on aggregated risk attributes of the counterparty node and a selected set of nodes reachable from that node via the edges in the transaction graph; and
send to the resource-limited device a response comprising said transaction-risk data for evaluation, at the device, of risk of the potential transaction.
